(19) United States
(12) Patent Application Publication
(10) Pub. No.: US 2025/0033660 A1
(43) Pub. Date: Jan. 30, 2025

(54) ADAPTING MACHINE OPERATION BASED ON ENVIRONMENTAL FACTORS FOR AUTONOMOUS SYSTEMS AND APPLICATIONS

(71) Applicant: NVIDIA Corporation, Santa Clara, CA (US)

(72) Inventors: Robin JENKIN, Morgan Hill, CA (US); Balaji HOLUR, Sunnyvale, CA (US)

(21) Appl. No.: 18/359,618

(22) Filed: Jul. 26, 2023

(51) Int. Cl. B60W 60/00; B60W 40/02

(52) U.S. Cl. CPC B60W 60/001; B60W 40/02; B60W 2556/40

(57) ABSTRACT

Embodiments of the present disclosure relate to adjusting operating parameters, settings, or configurations of a system based on identified factors corresponding to an environment. In some embodiments, the factors may respectively impact operation of a system and the factors may be weighted based on an amount of impact respectively caused to operation of the system. In some embodiments, the factors may additionally correspond to one or more information classes that may correspond to the environment. The one or more operations may additionally include determining one or more performance ability scores that may respectively correspond to the one or more information classes of the one or more factors. The operations may additionally include generating an overall impact score. Further, the operations may include modifying one or more operations of the system based at least on the overall impact score.

### BACKGROUND

Some systems may include one or more machine learning models that may be trained using data corresponding to one or more environments. In some instances, the one or more machine learning models may be trained to analyze input data (e.g., data not used to train the machine learning models) such that one or more systems corresponding to the machine learning models may perform one or more operations in response to the input data. For example, an ego-machine may include a perception module and/or system that may include a machine learning model. The machine learning model may be trained using data that may illustrate and/or show lane lines. Further, after the machine learning model is initially trained, the ego-machine may drive on one or more roads and may obtain data corresponding to its surroundings using one or more image sensors. The machine learning model may have been trained to analyze the data to recognize lane lines such that the ego-machine may perform one or more operations to stay within the lane lines.

In some instances, the one or more systems corresponding to the machine learning models may not be readily adaptable to new circumstances where the new circumstances include input data that may not correspond to the data used to train the machine learning models.

For example, an ego-machine may generate image data using one or more image sensors. Continuing the example, the image data may indicate that the ego-machine may transition from a paved road to an unpaved road. However, collecting the image data may not give the system enough data and/or information with enough time to adapt to changing circumstances effectively. Moreover, because machine learning models corresponding to one or more ego-machines (e.g., autonomous systems) may be trained using data corresponding to particular areas with particular circumstances, adapting to new areas and/or circumstances that may include new types of input data may be difficult.

### SUMMARY

According to one or more embodiments of the present disclosure, an overall impact score may be generated to convey information regarding one or more impacts to the system in a particular area based at least on a magnitude of one or more performance ability scores. Further, in some embodiments, one or more operations of the system may be changed based at least on the overall impact score. In some embodiments, one or more performance ability scores corresponding to the overall impact score may be determined, where the one or more performance ability scores may respectively correspond to one or more information classes corresponding to the one or more weighted factors.

In some embodiments, one or more weighted factors may be identified. In some embodiments, the one or more weighted factors may respectively impact the operation of a system and may be respectively weighted based at least on an amount of impact respectively caused to the operation of the system. In some embodiments, the one or more weighted factors may correspond to one or more information classes that may correspond to an area where the one or more information classes may categorize the one or more weighted factors into respective groups of the one or more weighted factors.

In some embodiments, the one or more information classes may include respective subsets of one or more of the weighted factors such that the one or more weighted factors may be categorized according to the respective information classes to which the one or more weighted factors may correspond. In some embodiments, the one or more performance ability scores may indicate one or more respective impacts that may be associated with performance of one or more operations corresponding to the system as respectively impacted by the one or more corresponding information classes. In some embodiments, the one or more performance ability scores may be determined based at least on the one or more weighted factors in the area that may correspond to the one or more information classes.

The embodiments of the present disclosure may increase the adaptability of systems to new areas and areas with diverse conditions by generating and/or determining one or more overall impact scores corresponding to the system and/or one or more particular areas.

### BRIEF DESCRIPTION OF THE DRAWINGS

The present systems and methods for modifying system operations based on overall impact scores corresponding to a particular area and/or the system are described in detail below with reference to the attached figures, wherein:

FIG. 1 illustrates an example system for determining the impact of an environment on the performance of a machine, in accordance with one or more embodiments of the present disclosure;

FIG. 2 illustrates an example environment for dynamically determining an overall impact score, in accordance with one or more embodiments of the present disclosure;

FIG. 3 is an example chart corresponding to generating an overall impact score associated with factors that may affect performance of autonomous driving operations by a machine, in accordance with one or more embodiments of the present disclosure;

FIG. 4 is a flow diagram showing a method for modifying one or more operations of a system based on an overall impact score, in accordance with one or more embodiments of the present disclosure;

FIG. 5A is an illustration of an example autonomous vehicle, in accordance with one or more embodiments of the present disclosure;

FIG. 5B is an example of camera locations and fields of view for the example autonomous vehicle of FIG. 5A, in accordance with one or more embodiments of the present disclosure;

FIG. 5C is a block diagram of an example system architecture for the example autonomous vehicle of FIG. 5A, in accordance with one or more embodiments of the present disclosure;

FIG. 5D is a system diagram for communication between cloud-based server(s) and the example autonomous vehicle of FIG. 5A, in accordance with one or more embodiments of the present disclosure;

FIG. 6 is a block diagram of an example computing device suitable for use in implementing one or more embodiments of the present disclosure; and

FIG. 7 is a block diagram of an example data center suitable for use in implementing one or more embodiments of the present disclosure.

### DETAILED DESCRIPTION

One or more embodiments of the present disclosure may relate to generating and/or determining an overall impact score corresponding to an environment. As used in the present disclosure, the overall impact score may be generated and/or determined to represent an overall set of circumstances and/or potential risks that may affect a system as operating in the environment. Additionally or alternatively, the overall impact score may represent an overall set of circumstances and/or potential risks that may affect one or more operations performed by the system in the environment.

In these and other embodiments, reference to the “environment” may include one or more discrete locations associated with the overall impact score. In some embodiments, the size of the environment corresponding to an overall impact score may be determined as one or more areas of the same size—e.g., every one-thousand square meters may represent a new environment that may correspond to a new overall impact score. In some embodiments, the environments described in the present disclosure may include differing environments depending on variable circumstances, factors, and/or risks associated with the environment. For example, environments may be discretized based on a density of roadways, a vehicle density or population (e.g., an average number of vehicles that traverse an area over some given time range), etc.

In some embodiments, the one or more overall impact scores may be generated and/or determined based on one or more performance ability scores corresponding to the system and/or the environment. In these and other embodiments, a performance ability score may represent a presence and/or magnitude of one or more potential impacts to the performance of one or more operations corresponding to the system. In some embodiments, the performance ability score may correspond to a class of information, referred to herein as “information class,” associated with the particular environment.

As used in the present disclosure, an information class may refer to a category of potential impacts, factors, and/or variables corresponding to an environment where the potential impacts, factors, and/or variables may affect performance of one or more operations corresponding to the system. In some embodiments, the information class may include one or more categories of potential impacts to performance of one or more operations of the system including, for example, traffic control, terrain, compliance, light, weather, traffic flow, and other categories affecting the system and/or operations of the system. In some embodiments, there may be one or more performance ability scores corresponding to one or more information classes corresponding to an environment. In some embodiments, there may be a performance ability score corresponding to each information class corresponding to the environment.

In some embodiments, the one or more performance ability scores may be determined based on previously collected data—or a lack thereof. In some embodiments, the previously collected data may include a collection of data and/or information that may have been previously generated and/or collected by the system via one or more sensors. Additionally or alternatively, the previously collected data may include historical data corresponding to the environment—e.g., data in the public domain, weather information, construction information, traffic information, accident statistics, etc.

Additionally or alternatively, the one or more performance ability scores and the overall impact score may be determined in a dynamic fashion based on data collected and/or generated using one or more sensors corresponding to the system while the system is in and/or around the corresponding environment. In some embodiments, sensor data generated using one or more sensors may include data and/or information that may indicate one or more changes to the area that may correspond to one or more changes to the one or more performance ability scores and/or overall impact scores.

In some embodiments, the overall impact score may be determined based on the one or more performance ability scores corresponding to the one or more information classes associated with the environment. In some embodiments, the overall impact score may be determined using an average, weighted sum, and/or other measurement of the one or more performance ability scores. However, an average of the performance ability scores may overemphasize information classes where performance of one or more operations corresponding to the system may not be affected. The average may show an overall impact score representing a low amount of impact to performance of the system despite one of the information classes having a performance ability score indicating a high amount of impact to the system's performance.

In some embodiments, the overall impact score may be determined using one or more formulas where one or more of the performance ability scores may be given disproportionate weight based on the amount of risk indicated by the performance ability score. For example, the one or more formulas may include one or more of a weighted summation, a Minkowski formulation, and/or other algorithm, equation, or formulation that may give outsized weight to performance ability scores indicating an increased impact on the performance of the system and/or one or more operations corresponding to the system.

In some embodiments, the system may change one or more operations based on the overall impact score and/or the performance ability scores corresponding to an area prior to entering the area. For example, the overall impact score may indicate a high impact to the performance of the system corresponding to the area. Further, one or more performance ability scores may indicate a high impact to system performance due to terrain or, more specifically, off-roading conditions. In preparation for one or more potential impacts associated with the environment, the system (e.g., autonomous vehicle and/or semi-autonomous vehicle) may switch into four-wheel drive to compensate for the potential terrain impacts associated with the environment.

Embodiments of the present disclosure may increase the adaptability of systems to new environments and environments with diverse conditions by generating and/or determining one or more overall impact scores corresponding to the system and/or one or more environments. By determining and/or generating one or more overall impact scores corresponding to one or more environments, the system may be better able to adapt to new circumstances and areas than a system adapting to new circumstances and/or areas without the one or more overall impact scores.

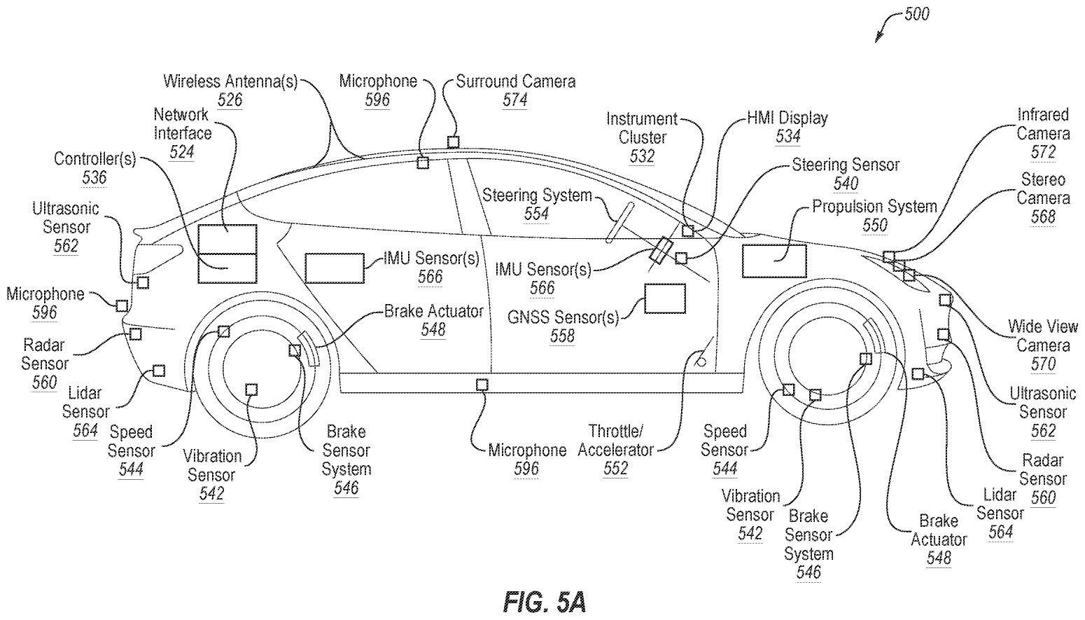

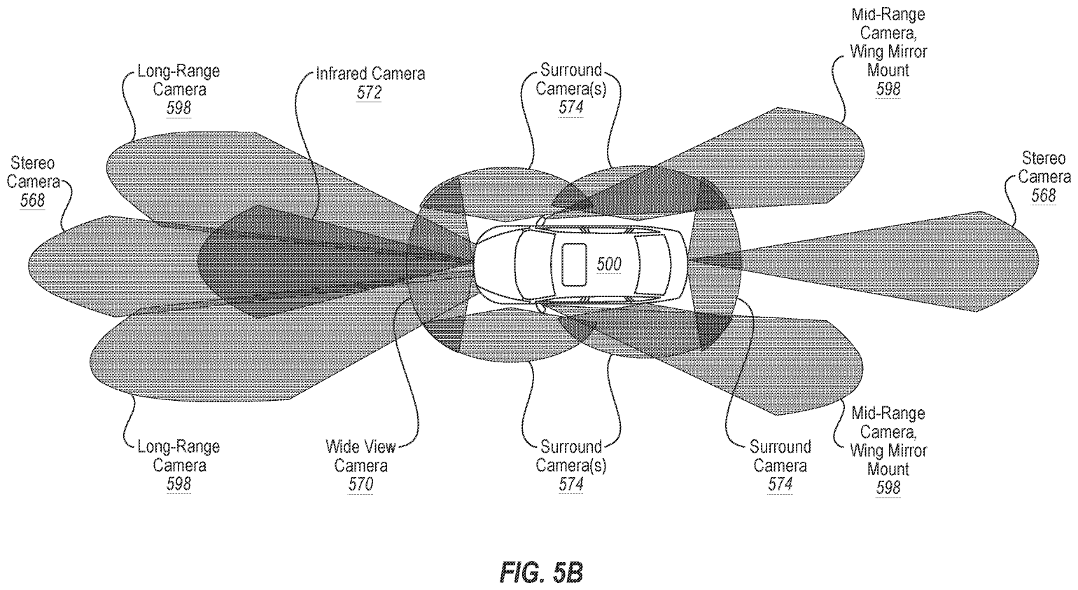

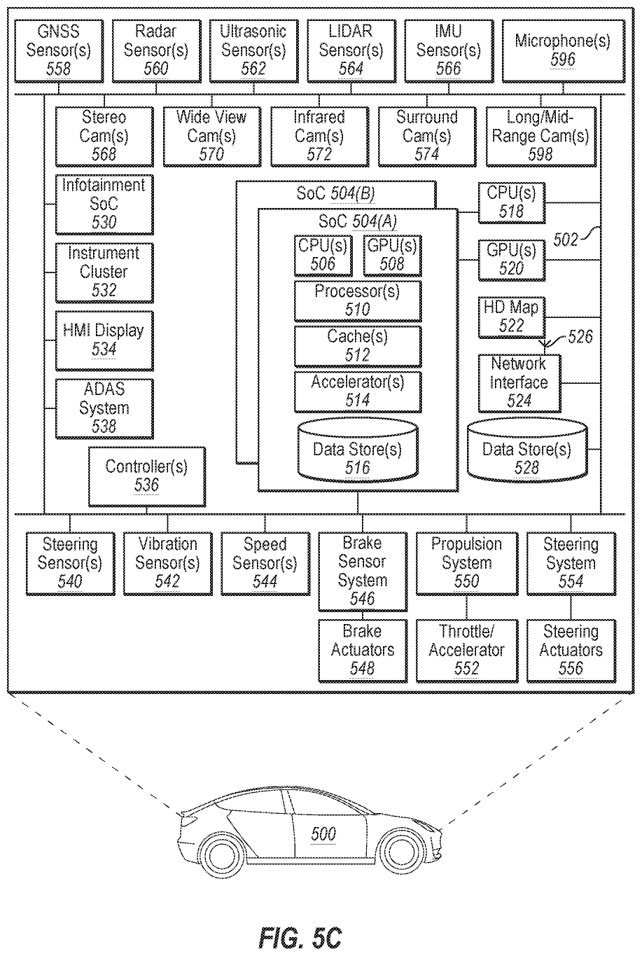

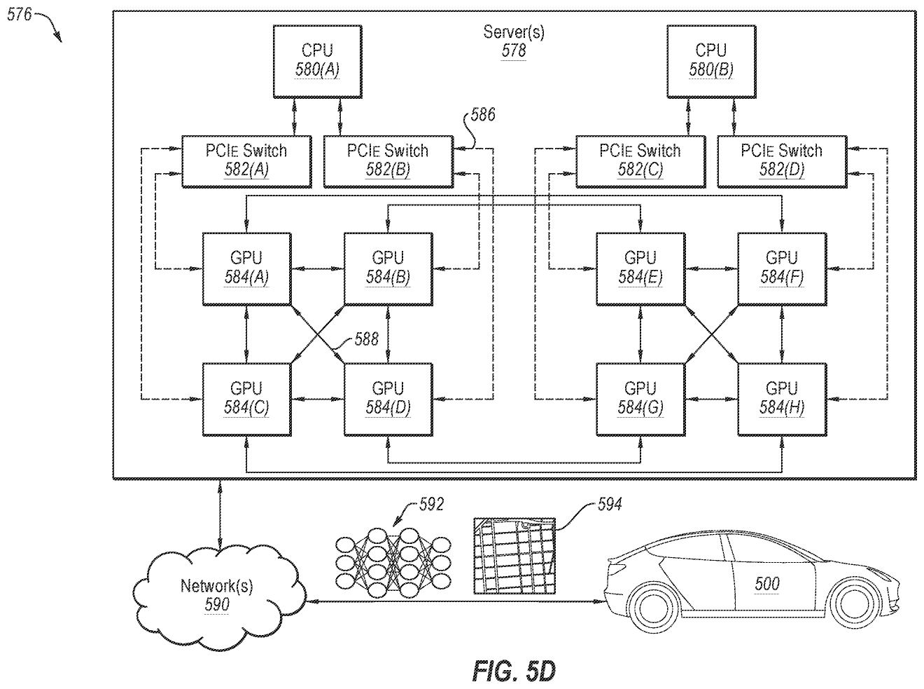

One or more of the embodiments disclosed herein may relate to generating one or more overall impact scores corresponding to the system and an environment where the one or more overall impact scores may be generated using one or more ego-machines capable of performing one or more autonomous and/or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous or semi-autonomous vehicle or machine 500 (alternatively referred to herein as “vehicle 500” or “ego-machine 500”) described with respect to FIGS. 5A-5D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs) that may process text, audio, and/or image/sensor data to generate one or more outputs, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

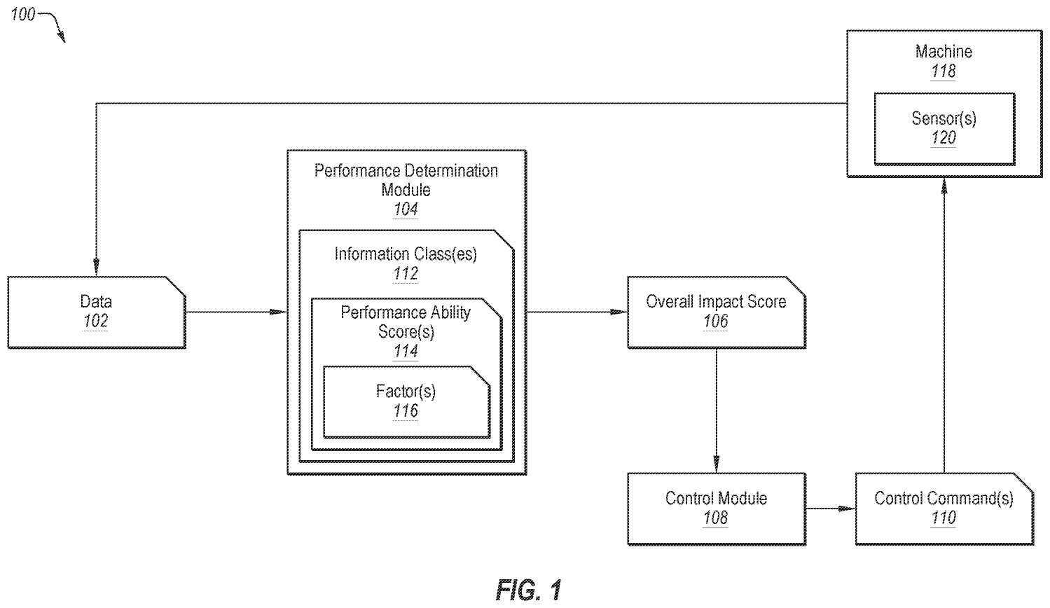

With respect to FIG. 1, FIG. 1 illustrates an example system 100 related to determining the impact of an environment on the performance of a machine 118, in accordance with one or more embodiments of the present disclosure. In some embodiments, one or more elements of the system 100 may be included in or part of the machine 118. Additionally or alternatively, one or more elements of the system 100 may be communicatively coupled to but separate from the machine 118.

The machine 118 may include one or more pieces of equipment, integrated processes, devices, and/or other systems that may be configured to perform one or more tasks. For example, the machine 118 may include one or more autonomous and/or semi-autonomous systems, vehicles, drones, industrial machinery, robots, and/or other systems that may perform one or more tasks. Further, the machine 118 may include multiple systems that may receive direction, prompts, etc. from one or more other system (e.g., the system 100). For example, multiple autonomous vehicles controlled and/or directed using one or more other systems.

In these or other embodiments, the system 100 may be configured to generate one or more control commands 110 that may cause the machine 118 to perform and/or modify one or more operations based on the overall impact score 106. In some embodiments, the system 100 may include a performance determination module 104 configured to generate the overall impact score 106 based on data 102. Additionally or alternatively, the system 100 may include a control module 108 configured to generate the control commands 110 based on the overall impact score 106.

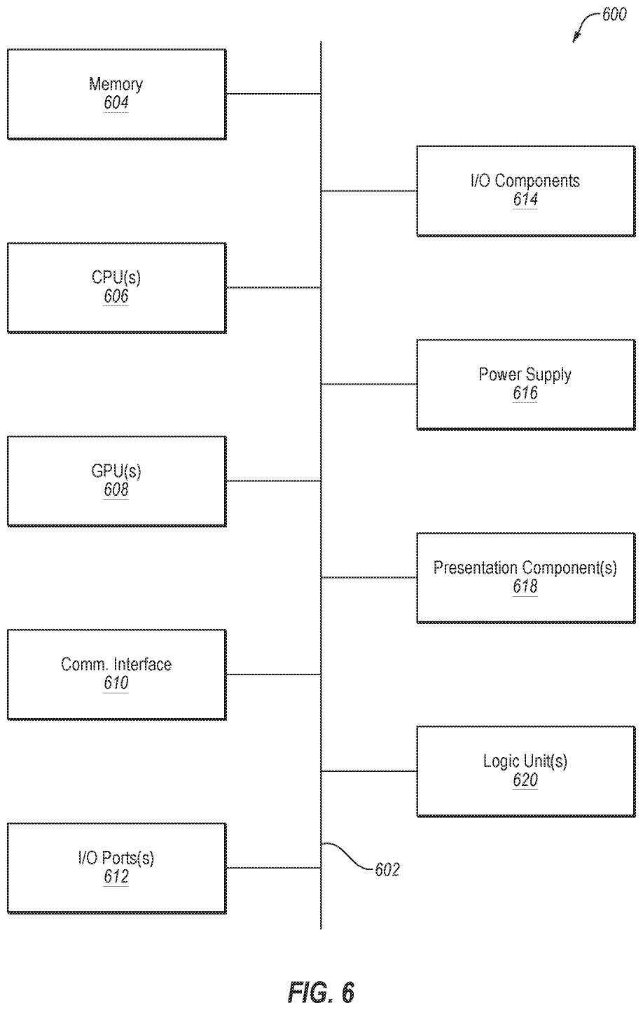

In some embodiments, the performance determination module 104 and/or the control module 108 may be implemented using hardware including one or more processors, central processing units (CPUs) graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In some other instances, one or more of the performance determination module 104 and/or the control module 108 may be implemented using a combination of hardware and software. In the present disclosure, operations described as being performed by a respective module may include operations that the respective module may direct a corresponding computing system to perform. In these or other embodiments, one or more of the performance determination module 104 and/or the control module 108 may be implemented by one or more computing devices, such as that described in further detail with respect to FIGS. 5A-5D, 6, and/or 7.

The data 102 may include one or more bits and/or bytes of data. In some embodiments, the data 102 may correspond to one or more bits of data and/or information that may describe one or more characteristics associated with the machine 118. For example, the data 102 may indicate that the machine 118 may be a vehicle with particular dimensions, horsepower, transmission system, drivetrain, headlights, passengers, etc.

Additionally or alternatively, in some embodiments, the data 102 may include data and/or information corresponding to one or more environments at which the machine 118 may be located. In some embodiments, the data 102 may describe and/or indicate one or more characteristics, features, and/or other qualities associated with the environment. For example, the data 102 may include information related to one or more environmental characteristics, variables, etc. For example, the data 102 may include information corresponding to weather, temperature, humidity, wind, ice, a road with particularly sharp turns, switch backs, road quality, traffic, wildlife warnings, time of day, time of year, etc. that may correspond to the environment where the machine 118 may be located. In the present disclosure, reference to an “environment” may also include reference to characteristics of the environment (e.g., characteristics of the environment during a time at which the machine 118 may be present).

In some embodiments, the data 102 may include data generated using one or more sensors 120 corresponding to the machine 118 and/or one or more modules associated with the machine 118. For example, in the context of the machine 118 being and/or corresponding to a drone, one or more sensors 120 may generate sensor data that may be included in the data 102. Continuing the example, the sensor data may indicate a wind speed and/or direction the wind may be blowing around the drone that may include wind at a particular speed and direction.

In some embodiments, the data 102 may include historically collected data corresponding to the machine 118, particular geographic areas, and/or environments associated with the machine 118 that may correspond to the overall impact score 106. In some embodiments, the data 102 may include, for example, historic weather data corresponding to the environment.

In some embodiments, the data 102, or portions of the data 102, may be found on one or more websites, in one or more other systems, information that may otherwise be in the public domain, and/or other data and/or information that may be associated with the machine 118, the system 100 and/or the environment within which the machine 118 may be located.

In some embodiments, the data may be gathered using one or more large language models (LLMs), such as by prompting the LLM(s) for information on a particular location or area. This may include performing retrieval augmentation in order to pull from one or more knowledge sources information that can be included in the prompt to the LLM(s) in order to inform the LLM(s) of information about a location or area. In some embodiments, the LLM(s) may have access to map information—e.g., textual representations of road topologies or layouts—and may use this textual representation of map (e.g., HD map) information to aid in the response generation.

In some embodiments, the data 102 may additionally include predicted and/or forecasted data corresponding to the environment and the machine 118 at a time and/or date when the machine 118 may be present in the environment. For example, the data 102 may indicate that the weather in March may typically be snowy or icy in the one or more geographic areas where the machine 118 may be expected and/or anticipated to be located. Additionally or alternatively, the data 102 may include weather forecasts on the date when the machine 118 may be present in the one or more geographic areas.

The performance determination module 104 may be configured to generate the overall impact score 106 corresponding to the machine 118 based on the data 102. In some embodiments, the performance determination module 104 may be configured to analyze the data 102 and/or one or more characteristics corresponding to the data 102 to determine, calculate, and/or otherwise generate the overall impact score 106.

In some embodiments, the performance determination module 104 may be included in the machine 118 for which the overall impact score 106 may be generated. Additionally or alternatively, the performance determination module 104 may additionally or alternatively be included in one or more other systems that may determine the overall impact score 106 (e.g., in a cloud based service or system), and this information may be shared with an ego-machine over a network(s). For example, this information may be encoded in map data (e.g., encoded in an HD map), and may be used as additional information when navigating a particular road, area, region, location, etc. As referred to in the present disclosure, the overall impact score 106 may include one or more values that may include one or more data types (e.g., integer, float, Boolean, string, char, etc.). In some embodiments, the one or more values corresponding to the overall impact score 106 may indicate the overall set of circumstances that may affect the machine 118 while in the corresponding environment.

In some embodiments, the performance determination module 104 may be configured to generate and/or determine the overall impact score 106 based on one or more performance ability scores 114 corresponding to the machine 118 and/or the environment. In these or other embodiments, a particular performance ability score 114 may represent a presence and/or magnitude of one or more potential impacts to the performance of one or more operations of the machine 118 as affected by one or more characteristics of the environment. In some embodiments, the performance ability scores 114 may respectively correspond to corresponding information classes 112.

In some embodiments, the information class 112 may refer to a broad category that may include various characteristics, features, indicators, circumstances, and/or potential impacts that may affect the machine 118 and/or operations of the machine 118. In some embodiments, the information classes 112 may include any number of different categories of different impacts corresponding to the machine 118 in a particular area. For example, in the context of the machine 118 being a vehicle, the information classes 112 may include traffic control, terrain, compliance, light, weather, traffic flow, and other categories that may include factors 116 that may affect the machine 118 and/or operations of the machine 118 in the particular area.

In some embodiments, the various potential impacts corresponding to the information classes 112 may include the factors 116. In some embodiments, each information class 112 may include one or more factors 116 that may indicate various potential impacts to the machine 118 and/or operations corresponding to the machine 118.

By way of example and not limitation, in the context of the machine 118 being a vehicle, traffic flow may be a particular information class 112. Continuing the example, the particular information class 112 corresponding to the traffic flow may include a number of particular factors 116 that may affect the performance of the vehicle. For example, such factors 116 may include whether the environment includes a complex junction, whether a road is narrow or wide, the speed limit corresponding to the environment, the number of lanes on one or more roads corresponding to the environment, etc. Further, the aggregation of the one or more factors 116 may correspond to an overall impact to the vehicle corresponding to the traffic flow information class 112.

In some embodiments, a particular information class 112 corresponding to terrain may include, for example, one or more factors 116 including tight turns, elevation change, poor road conditions, rock fall, off-road conditions, potholes, narrow roads, etc. In some embodiments, the information class 112 corresponding to compliance may include, for example, one or more factors 116 including non-compliant lane markings, non-compliant street signage, pedestrians in the roadway, unpredictable traffic direction, excessive usage of car horns, etc. In some embodiments, the information class 112 corresponding to traffic mix that may include, for example, one or more factors 116 including animal traffic in the road, a large number of motorbikes on the road, a large number of cycles on the road, comingled traffic, etc. In some embodiments, the information class 112 corresponding to traffic control may include, for example, one or more factors 116 including signage not being present, traffic lights not being present, no road markings, etc. In some embodiments, the information class 112 corresponding to light may include, for example, one or more factors 116 including dark roads, non-reflective road signage, high use of lights for billboards along the road, etc.

The above examples are illustrative and are not meant to be limiting. The factors 116 included in the information classes 112 may include any relevant variable, characteristic, or other impact that may affect the machine 118 and/or one or more operations corresponding to the machine 118 while the machine 118 may be within a particular environment.

In some embodiments, the aggregation of factors 116 corresponding to an information class 112 may result in a score that may indicate an overall effect that the factors 116 corresponding to an information class 112 may have on the machine 118. In some embodiments, the score corresponding to one or more information classes 112 may correspond to a performance ability score 114. In some embodiments, there may be a performance ability score 114 corresponding to each information class 112 corresponding to the environment.

By way of example and not limitation, weather may be a particular information class 112 for which a particular performance ability score 114 may be determined. Continuing the example, the particular information class 112 corresponding to the weather may include one or more factors 116 that may affect performance of one or more operations of the machine 118, such as, whether the area and/or environment may be prone to icing, prone to rain and/or flooding, presence, or absence of snow, etc. Further, the particular performance ability score 114 corresponding to the particular information class 112 related to weather may represent an overall effect on the performance of the machine 118 and/or the performance of one or more operations corresponding to the machine 118 associated with the weather.

In some embodiments, one or more performance ability scores 114 may be determined for one or more corresponding information classes 112 by determining whether the factors 116 corresponding to the information class 112 may be present in the environment where the machine 118 may also be present.

In some embodiments, to determine and/or calculate a performance ability score 114 corresponding to an environment using the factors 116, it may be determined that the factors 116 may be present or absent from the environment. In some embodiments, the factors 116 may be represented using a binary “1” or “0” indicating that the factors 116 that may affect the machine 118 are present in the environment.

By way of example and not limitation, in an information class 112 corresponding to weather in a particular environment, the information class 112 may include four factors 116, the four factors 116 may include prone to icing, prone to flooding, snow present, and high winds. Continuing the example, high winds and heavy rain may be present in the environment and, to indicate the weather, the factors 116 corresponding to high winds and prone to flooding may be indicated using a “1” and the prone to icing and snow present factors 116 may be absent from the environment and therefore indicated using a “0.”

In some embodiments, the factors 116 may be weighted. In some embodiments, the factors 116 may be weighted based on an amount that the presence of the factors 116 may affect the machine 118 and/or one or more operations of the machine 118. For example, in the context of the factors 116 listed corresponding to the weather, the machine 118 may be affected more by the presence of snow and/or the environment being prone to flooding than high winds and/or the environment being prone to ice. Therefore, continuing the example, the weights corresponding to the presence of snow and/or prone to flooding may be weighted at 0.7 each while the environment being prone to ice and/or high wind may be weighted at 0.3.

In these or other embodiments, the values and/or scale used to determine one or more weights corresponding to the factors 116 may vary. In some embodiments, the weights may include one or more data types that may provide information associated with an impact to the machine 118.

In some embodiments, the weights corresponding to the one or more information classes 112 may be determined dynamically using data and/or information corresponding to similar machines. For example, in the context of the machine 118 as a vehicle, several vehicles with similar characteristics may encounter one or more factors 116 corresponding to an environment. Continuing the example, data 102 may be obtained corresponding to effects of one or more factors 116 on the vehicles within the environment. The factors 116 may be weighted based on the severity of the impact of the various factors 116 on the vehicles.

In some embodiments, one or more performance ability scores 114 may be determined based on the presence of one or more factors 116 and the corresponding weights of the one or more factors 116. In some embodiments, an increase in the weight corresponding to the factors 116 may increase the impact of the factor 116 on determining a corresponding performance ability score 114.

An example expression for determining one or more performance ability scores 114 based on one or more factors 116 and weights corresponding to the one or more factors 116 may be illustrated using the expression defined below:

$${F}_{n} = [ \begin{matrix}{C}_{1} \\ ⋮ \\ {C}_{i}\end{matrix} ] \cdot [ \begin{matrix}{W}_{1} \\ ⋮ \\ {W}_{i}\end{matrix} ] \qquad ( 1 )$$

Where Fₙ is a particular performance ability score 114 of a corresponding information class 112 indicated using the number “n”. Further, C is a factor 116 in a number of factors 116 “i” corresponding to the information class 112 for which Fₙ is determined. In some embodiments, C may indicate a binary “1” or “0” corresponding to whether the respective factors 116 may be present or absent from the environment. Further, where W is a weight corresponding to one or more of the factors 116, C corresponding to the performance ability score 114 “Fₙ.”

By way of example and not limitation, in the context of the machine 118 as a vehicle, the performance ability score 114 may be determined corresponding to an information class 112 associated with the terrain of a particular environment where the vehicle may be travelling. Continuing the example, the performance ability score 114 may be determined based on at least two factors 116:(1) tight turns; and (2) rockslide. Further, it may be determined that tight turns exist in the particular environment and that a rockslide has occurred in the particular environment. Further, the weight associated with the first factor 116 corresponding to tight turns may be 0.25 which may be in contrast to the weight associated with the rockslide that may be 0.75. The rockslide may be assigned a larger weight than the tight turns because the rockslide may have a larger impact on the vehicle and/or one or more operations corresponding to the vehicle in the particular environment than the tight turns. Further continuing the example, because both tight turns and the rockslide are present in the environment, the performance ability score 114, in accordance with equation (1) may be 1.0−(Fₙ=(1) (0.25)+(1) (0.75)=1.0).

Equation (1) is an example expression that may be used to determine one or more performance ability scores 114 based on one or more factors 116 corresponding to a respective information class 112. One or more other equations, formulas, expressions, etc. may be used to determine the respective performance ability scores 114 based on factors 116 corresponding to one or more information classes 112.

In some embodiments, the lower the performance ability score 114 associated with an information class 112, the worse the machine 118 may perform one or more operations. Similarly, the higher the performance ability score 114 associated with the information class 112, the better the machine 118 may perform one or more operations. Additionally or alternatively, a lower performance ability score 114 associated with the information class 112 may correspond to better performance of one or more operations by the machine 118 within a particular environment and a higher performance ability score 114 associated with the information class 112 may correspond to worse performance of one or more operations by the machine 118 within the particular environment.

In some embodiments, a decrease in performance of one or more operations by the machine 118 may correspond to an increase in risk to the machine 118 and/or one or more other systems, individuals, property, etc. associated with the environment corresponding to the machine 118. Additionally or alternatively, the increase in performance of one or more operations of the machine 118 may correspond to a decrease in risk to the machine 118 and/or one or more other systems, individuals, property, etc. associated with the environment corresponding to the machine 118.

In some embodiments, the one or more performance ability scores 114 may be determined in a dynamic fashion based on data collected and/or generated using one or more sensors 120 corresponding to the machine 118. In some embodiments, sensor data generated using one or more sensors 120 may include data and/or information that may indicate one or more changes to the environment and/or the machine 118 that may correspond to one or more changes to the performance ability scores 114 and/or the overall impact score 106.

For example, the machine 118 within a particular environment may typically have a particular performance ability score 114 corresponding to traffic which may indicate a low amount of impact to the performance of the machine 118 (e.g., low traffic flow, clear lane lines, traffic moving consistent with the speed limit, etc.). Continuing the example, the machine 118 may obtain sensor data that may be generated using one or more sensors 120 disposed thereon. The sensor data may indicate a high amount of traffic flow, one or more accidents corresponding to a particular location, etc. In this instance, the performance ability score 114 associated with traffic in the environment corresponding to the machine 118 may accordingly change and indicate an increased amount of risk and/or a decrease in potential performance of the machine 118.

In some embodiments, a lack of information about a particular location, area, region, etc. may be a factor considered. For example, for terrain that has yet to be encountered, or has only been minimally encountered, an information class 302 may include a knowledge or information level about the particular location—e.g., no information, low information, high information, etc. As such, where there is little to no information, the system may perform differently-such as by proceeding more cautiously or slowly-until a requisite amount of data is collected and fed back into the system to update other information classes 302 and factors 304.

In some embodiments, the overall impact score 106 may be determined based on the one or more performance ability scores 114 corresponding to the one or more information classes 112 associated with the machine 118. In some embodiments, the overall impact score 106 may include data and/or information corresponding to the overall set of circumstances corresponding to the machine 118 and/or one or more areas and/or environments wherein the machine 118 may be located. In some embodiments, the overall impact score 106 may be determined using an average of the one or more performance ability scores 114. However, an average of the performance ability scores 114 may overemphasize information classes 112 where performance of one or more operations corresponding to the machine 118 may not be affected. The average may show an overall impact score 106 representing a low amount of impact to performance of the machine 118 despite one of the information classes 112 having a performance ability score 114 indicating a high amount of impact to performance of one or more operations of the machine 118.

For example, in the context of measuring performance ability scores 114 on a scale from zero to five, zero indicating no effect on the performance of the machine 118 and five indicating a high effect on the performance of the machine 118, an overall impact score 106 may be determined corresponding to the environment 100. The overall impact score 106 may be determined based on ten performance ability scores 114 corresponding to ten information classes 112. Nine of the information classes 112 may correspond to a performance ability score 114 of zero while one of the information classes 112 may correspond to a performance ability score 114 of five. Further, the overall impact score 106 may be an average of the performance ability scores 114, in this case, the overall impact score 106 may be 0.5 which may indicate a low impact to the performance of the machine 118. However, in reality, the environment may include at least one performance ability score 114 corresponding to one of the ten information classes 112 that may have a large impact on the performance of the machine 118. Therefore, in some instances, an average of the performance ability scores 114 may not provide an accurate indication of impact and accordingly may not be useful in determining the overall impact score 106.

Additionally or alternatively, the overall impact score 106 may be determined where the one or more performance ability scores 114 may indicate a higher impact to the performance of the machine 118 and may have a disproportionate effect on the overall impact score 106. In some embodiments, the greater the impact to the operations of the machine 118 associated with the one or more performance ability scores 114, the more of an impact the one or more performance ability scores 114 may have on the overall impact score 106. Continuing the example corresponding to the ten information classes 112, the one information class 112 corresponding to the performance ability score 114 of five would have an outsized impact on the overall impact score 106 as compared to the other nine information classes 112 corresponding to performance ability scores 114 of zero.

In some embodiments, the performance determination module 104 may determine the overall impact score 106 using one or more formulas where one or more of the performance ability scores 114 may be given disproportionate weight based on the effect on the machine 118 indicated by the one or more performance ability scores 114. For example, the one or more formulas may include one or more of a weighted summation, a Minkowski formulation, and/or other algorithm, expression, equation, or formulation that may give outsized weight to performance ability scores 114 indicating an increased impact on the performance of the system and/or one or more operations corresponding to the machine 118.

An example expression that may be used to determine the overall impact score 106 may be defined below:

$$O = - {( {\sum }_{n} {( - {F}_{n} )}^{S} )}^{\frac{1}{S}} \qquad ( 2 )$$

Where O is the overall impact score 106 corresponding to the machine 118, Fₙ corresponds to one or more performance ability scores 114 that may have been defined using equation (1). The number “n” indicates a particular information class 112 to which the performance ability score 114 may correspond, and where S is the sensitivity that one performance impact score 114 may have on the overall impact score 106.

In some embodiments, an increase in the sensitivity “S” corresponding to equation (2) increases the amount that one performance ability score 114 may affect the overall impact score 106. For example, continuing the example where nine performance ability scores 114 may be zero and one performance ability score 114 may be five, an average of the performance ability scores 114 may be 0.5 which may correspond to the overall impact score 106. However, increasing the sensitivity in equation (2) may increase the overall impact score 106 to reflect the one performance ability score 114 of five—e.g., a high sensitivity may lead to an overall impact score 106 of 4.5.

In some embodiments, the sensitivity “S” may be determined based on the machine 118 and/or the environment corresponding to the machine 118. In some embodiments, the sensitivity may be increased for the machine 118 that may be more fragile than another system that may be more rugged. As another example, the sensitivity may be increased in instances in which the environment may be a substantial distance from any assistance and/or repairs should the machine 118 break down. Additionally or alternatively, in some embodiments, the sensitivity may increase depending on the severity of potential impacts corresponding to the factors 116. For example, the environment may be a road on a particularly steep mountain. Continuing the example, the sensitivity may be increased because, while the machine 118 may be configured to navigate the road with relative ease, the impact and/or consequences of the one or more factors 116 may be more severe—e.g., driving off the edge of the mountain.

In some embodiments, the performance determination module 104 may be configured to determine, re-determine, and/or update the overall impact score 106 based on one or more adjustments or changes to one or more operations corresponding to the machine 118. For example, in the context of an ego-machine driving on a road that may be rated for off-road vehicles, one or more control commands 110 corresponding to the ego-machine may cause the ego-machine to change from two-wheel drive to four-wheel drive, decrease the speed of the ego-machine, and to downshift from 4th gear to 1st gear. The performance determination module 104, based on the information corresponding to the one or more changes to the ego-machine corresponding to one or more control commands 110, may decrease an overall impact score 106 corresponding to the environment and the ego-machine. The performance determination module 104 may decrease the overall impact score 106 because the changes made to one or more operations corresponding to the ego-machine may decrease the potential impact of one or more factors 116 on the performance of the ego-machine within the particular environment.

In some embodiments, the overall impact score 106 may be determined corresponding to one or more environments that the machine 118 may encounter on, for example, a planned route. By way of example and not limitation, in the context of the machine 118 as an ego-machine, the ego-machine may be directed to travel from point A to point B. Further, the overall impact score 106 may be determined corresponding to one or more areas along the route from point A to point B. The overall impact score 106 may have been determined using the performance determination module 104 based on data corresponding to each of the areas, the environments of the areas, and information and/or data corresponding to the ego-machine. Further continuing the example, the overall impact score 106 corresponding to the areas along the route from point A to point B may also change dynamically using sensor data corresponding to the ego-machine and/or other data updating information corresponding to the four areas while the ego-machine may be travelling.

In some embodiments, the control module 108 may be configured to generate one or more control commands 110 based on the overall impact score 106. In some embodiments, the control module 108 may be configured to receive and/or otherwise obtain the overall impact score 106 that may have been determined, re-determined, calculated, and/or generated using the performance determination module 104.

In some embodiments, the overall impact score 106 may include information corresponding to a determination corresponding to the overall impact score 106. For example, along with a value corresponding to the overall impact score 106, information corresponding to the performance ability scores 114 determined using one or more factors 116 corresponding to one or more information classes 112 may additionally be included in the overall impact score 106. In some embodiments, the overall impact score 106 may be received and/or otherwise obtained by the control module 108.

In some embodiments, the control module 108 may be included in the machine 118 for which the control commands 110 may be generated. Additionally or alternatively, the control module 108 may not be included in the machine 118; rather, the control module 108 may be included in one or more other systems that may determine the one or more control commands 110. In some embodiments, the one or more control commands 110 may be configured to cause the machine 118 to perform one or more operations.

In some embodiments, the control module 108 may be configured to interpret the overall impact score 106 and, from the overall impact score 106, the control module 108 may be configured to generate one or more control commands 110.

In some embodiments, the control module 108 may not generate one or more control commands 110 and/or continue current operations performed by the machine 118 unless and/or until the overall impact score 106 may reach a predetermined threshold. In some embodiments, once the overall impact score 106 reaches a pre-determined threshold, the control module 108 may be configured to generate one or more control commands 110 to cause the machine 118 to perform one or more operations in response to the overall impact score 106.

In some embodiments, the predetermined threshold may be determined based on the environment, geographic area, and/or the machine 118. For example, the machine 118 may include a particularly fragile and/or sensitive system and/or one or more sensitive and fragile parts (e.g., a fragile airfoil corresponding to a drone). Continuing the example, because the machine 118 may be particularly fragile, the predetermined threshold corresponding to the overall impact score 106 may be comparatively lower than another overall impact score 106 corresponding to a more rugged machine 118.

Additionally or alternatively, the predetermined threshold may be determined based on a heuristic analysis. For example, it may be found that the machine 118 may function at a high level while also adapting to new areas and/or circumstances when the predetermined threshold corresponding to the overall impact score 106 may be at a particular value.

Additionally or alternatively, the predetermined threshold may be determined based on one or more percentages corresponding to a maximum overall impact score 106. The maximum overall impact score 106 may be determined based on the number of factors 116 corresponding to the information classes 112 all being present in the environment. For example, a maximum overall impact score 106 may be 10. Continuing the example, the predetermined threshold may be 60% of the maximum overall impact score 106 or when the overall impact score 106 reaches a score of 6.

In some embodiments, the control module 108 may generate one or more control commands 110 based on the overall impact score 106. In some embodiments, the control module 108 may generate one or more control commands 110 that may direct the machine 118 to continue operations even when the overall impact score 106 reaches a predetermined threshold. Additionally or alternatively, one or more control commands 110 may be generated to modify one or more operations of the machine 118 that may compensate for one or more potential impacts to the machine 118 indicated by the overall impact score 106.

In some embodiments, the control module 108 may generate one or more control commands 110 that may cause the machine 118 to perform one or more operations. In some embodiments, the one or more control commands 110 may direct the machine 118 to continue performing one or more operations. Additionally or alternatively, the one or more control commands 110 may cause the machine 118 to change and/or modify one or more operations. For example, the one or more control commands 110 may cause one or more operations, the operations may include accelerating the machine 118, decelerating the machine 118, turning, conserving energy and/or power corresponding to the machine 118, activating and/or deactivating one or more sensors 120, modifying one or more perception modules corresponding to the machine 118, change a weighting of certain factors or parameters used to make planning, control, or actuation decisions (e.g., where there is ice or snow, weigh traction feedback more heavily in determining vehicle controls), and/or any other operation that may affect the performance of the machine 118.

In some embodiments, the one or more control commands 110 may be generated using the control module 108 based on the overall impact score 106, the performance ability scores 114, and/or the factors 116. In some embodiments, the one or more control commands 110 may be configured to cause the machine 118 to perform one or more operations that may help alleviate some of the potential impacts to the machine 118 indicated by the overall impact score 106.

By way of example and not limitation, in the context of the machine 118 as a vehicle, the overall impact score 106 may indicate an amount of impact to the machine 118 within the environment. Further continuing the example, information corresponding to the overall impact score 106 (e.g., the performance impact score(s) 114 and/or the factors 116) may indicate a long stretch of road and a comparatively low amount of energy to carry the vehicle through the stretch of road. Based on the overall impact score 106 and/or information corresponding to the overall impact score 106, one or more control commands 110 may cause the vehicle to enter into a power and/or energy saving mode where at least some functions may be reduced or disabled to draw less power from the vehicle. Further, the control commands 110 causing the vehicle to enter power save mode may help alleviate the potential impact of the environment on the vehicle, and more particularly, that the vehicle may run out of energy before being refilled or charged.

In some embodiments, the control commands 110 may direct and/or cause one or more systems corresponding to the machine 118 to perform one or more operations together to compensate for the overall impact score 106 and/or information corresponding to the overall impact score 106.

By way of example and not limitation, in the context of the machine 118 as an ego-machine, one or more sensors 120 corresponding to the ego-machine may generate sensor data corresponding to a particular environment. Further, the sensor data, in conjunction with a neural network or other perception module may determine that the particular environment may include too much traffic and/or that the ego-machine may be unable to detect one or more lane lines and/or road markers to navigate safely. Because the environment may include a large amount of traffic and/or the ego-machine may not be able to detect lane markers, the factors 116 corresponding to the traffic may be present and therefore increase the performance ability score 114 corresponding to one or more information classes 112. Further, the overall impact score 106 may correspondingly increase because one or more performance ability scores 114 may have correspondingly increased. As a result, the overall impact score 106 may be relatively high triggering the control module 108 to generate one or more corresponding control commands 110. Continuing the example, the control module 108 may direct the ego-machine to connect with a number of other ego-machines and directing the ego-machine to form one or more virtual lanes, for example, by modifying one or more perception modules, image signal processors (ISPs), or other systems corresponding to the ego-machine. The virtual lanes and/or other changes or modifications to behavior corresponding to the ego-machine may decrease the risk and/or impact corresponding to the traffic associated with the overall impact score 106.

As an additional example, the system 100 may direct, for example, a fleet of autonomous vehicles. Continuing the example, a map may be generated where one or more sub-areas corresponding to the map may be associated with the overall impact score 106 based on data 102 that may have been received and/or is actively received by the system 100. Further, the system 100 may be configured to direct one or more of the autonomous vehicles in the fleet to perform one or more operations based on the overall impact score 106 associated with respective sub-areas of the map—e.g., the system 100 may direct the fleet to form virtual lanes and/or exchange information that may change one or more operations of individual autonomous vehicles to mitigate impacts to performance of individual autonomous vehicles based on the overall impact score 106.

In some embodiments, the control module 108 may be configured to change and/or modify one or more operations preemptively in response to the overall impact score 106. For example, in the context of the machine 118 as an industrial robot operating in a particular building, the overall impact score 106 corresponding to one floor of the particular building and corresponding to the industrial robot may indicate an increased potential impact to the performance of the industrial robot caused by oil spillage. Prior to the industrial robot reaching the floor corresponding to the high overall impact score 106, the control module 108 may cause the industrial robot to decrease its speed thereby decreasing the potential impact to the performance of the industrial robot slipping on the oil based on the overall impact score 106 corresponding to respective sub-areas of the map.

As an additional example, in the context of the machine 118 as an ego-machine, the overall impact score 106 corresponding to a particular environment may reflect that one or more factors 116 corresponding to the environment may negatively impact the machine 118 and/or one or more operations of the machine 118. The information corresponding to the overall impact score 106 may indicate that the environment includes difficult terrain for the ego-machine. In response, and prior to the ego-machine reaching the environment with difficult terrain, the control module 108 may be configured to generate one or more control commands 110 that may preset suspension settings corresponding to the ego-machine. Further, the preset suspension settings may increase a capacity of the ego-machine to navigate the difficult terrain corresponding to the environment.

Modifications, additions, or omissions may be made to FIG. 1 without departing from the scope of the present disclosure. For example, the amount of data 102 used, the number of information classes 112, performance ability scores 114, and/or factors 116 may vary. Further, the performance determination module 104 and/or the control module 108 may not be included in the machine 118, in some embodiments, the performance determination module 104 and/or the control module 108 may be included in one or more other systems that may direct one or more operations corresponding to the machine 118. Additionally or alternatively, the machine 118 may include the performance determination module 104 and/or control module 108 but may be generating one or more control commands 110 directing the performance one or more other systems.

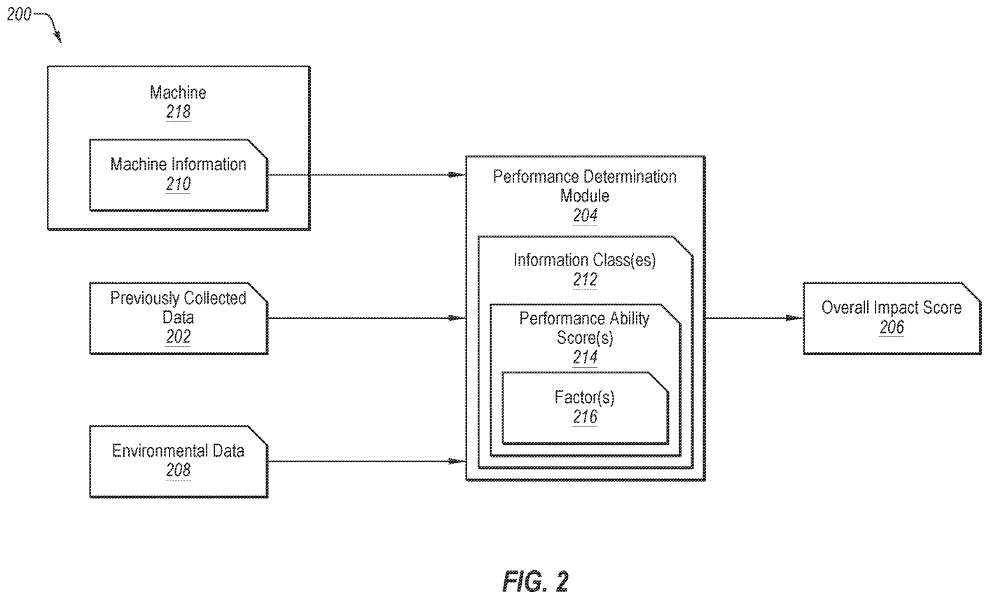

FIG. 2 illustrates an example environment 200 for dynamically determining an overall impact score 206, in accordance with one or more embodiments of the present disclosure. In some embodiments, the environment 200 may include a performance determination module 204 that may determine the overall impact score 206 based on previously collected data 202, environmental sensor data 208, and/or machine information 210.

In some embodiments, the performance determination module 204 may be implemented using hardware including one or more processors, central processing units (CPUs) graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In some other instances, one or more of the performance determination module 204 may be implemented using a combination of hardware and software. In the present disclosure, operations described as being performed by the performance determination module 204 may include operations that the performance determination module 204 may direct a corresponding computing system to perform. In these or other embodiments, the performance determination module 204 may be implemented by one or more computing devices, such as that described in further detail with respect to FIGS. 5A-5D, 6, and/or 7.

In some embodiments, the performance determination module 204 may be configured to determine, calculate, and/or synthesize the overall impact score 206. In these or other embodiments, the overall impact score 206 may correspond to a machine 218 and may relate to performance of one or more operations by the machine 218 within a particular environment. In some embodiments, the overall impact score 206 may be determined based on one or more information classes 212, performance ability scores 214, and/or factors 216. In some embodiments, the performance determination module 204 may be the same as and/or analogous to the performance determination module 104 described and/or illustrated further in the present disclosure, such as, for example, with respect to FIG. 1.

In some embodiments, the overall impact score 206 may represent an overall set of circumstances and/or potential risks that may affect the machine 218 operating in the particular environment. In some embodiments, the overall impact score 206 may be determined based on one or more information classes 212, performance ability scores 214, and/or factors 216. In these or other embodiments, the overall impact score 206, the information classes 212, the performance ability scores 214, and/or the factors 216 may be the same as and/or analogous to the overall impact score 106, the information classes 112, the performance ability scores 114, and/or the factors 116 described and/or illustrated further in the present disclosure, such as, for example, with respect to FIG. 1.

In some embodiments, the machine 218 may include one or more pieces of equipment, integrated processes, devices, and/or other systems that may be configured to perform one or more tasks. Further, the machine 218 may include multiple systems that may receive direction, prompts, etc. from one or more other systems. Examples of the machine 218 may include one or more drones, ego-machines, robot, autonomous systems, semi-autonomous systems, and other systems that may be configured to execute one or more processes in response to one or more overall impact scores 206. In these and other embodiments, the machine 218 may be the same as and/or analogous to the machine 118 described and/or illustrated further in the present disclosure, such as, for example, with respect to FIG. 1.

In some embodiments, the machine information 210 may include data and/or information corresponding to the machine 218. In some embodiments, the machine information 210 may include characteristics corresponding to the machine 218. Examples of machine information 210 may include dimensions of the machine 218 (e.g., height, weight, length, etc.), processing power, energy storage and capacity, transmission, horsepower, transmission system, drivetrain, headlights, passengers, and other information corresponding to one or more characteristics of the machine 218. In these or other embodiments, the machine information 210 may be an example of the data 102 described and/or illustrated further in the present disclosure, such as, for example, with respect to FIG. 1.

In some embodiments, previously collected data 202 may include any data that may not be collected and/or generated while the machine 218 may be within the particular environment. In some embodiments, the previously collected data 202 may include historical data corresponding to the environment. For example, historic weather data, construction sites, portions of the environment where traffic accidents may have occurred, roads built, other map data corresponding to the environment, and/or any other data and/or information corresponding to the particular environment. In these or other embodiments, the previously collected data 202 may be an example of the data 102 described and/or illustrated further in the present disclosure, such as, for example, with respect to FIG. 1.

In some embodiments, the environmental data 208 may include data and/or information that may be generated and/or collected while the machine 218 may be within the particular environment. In some embodiments, the environmental data 208 may include data collected and/or otherwise obtained using one or more sensors corresponding to the machine 218 within the environment. Additionally or alternatively, the environmental data 208 may be received and/or otherwise obtained from one or more other sources such as, for example, other systems, sensors, machines, devices, etc. that may obtain and/or collect data and/or information corresponding to the environment.

In some embodiments, the environmental data 208 may include sensor data generated using one or more sensors corresponding to the machine 218. For example, the machine 218 may include one or more image sensors that may generate image data corresponding to the environment (e.g., the surrounding area corresponding to the machine 218). In some embodiments, the environment data 208 may include data collected using one or more other devices and/or systems that may be separate from the machine 218. For example, the environmental data 208 may include a video stream (e.g., obtained using one or more cameras disposed in the environment) corresponding to the environment while the machine 218 is in the environment. As an additional example, the environmental data 208 may include real time or substantially real time data reflecting conditions corresponding to the environment while the machine 218 may be in the environment (e.g., temperature, humidity, wind speed, wildlife warnings, amounts of rain, snow, sleet, hail, time of day, time of year, etc.).

In some embodiments, the performance determination module 204 may be configured to dynamically determine and/or re-determine one or more overall impact scores 206 based on the machine information 210, the previously collected data 202, and/or the environmental data 208. In some embodiments, re-determining the overall impact score 206 may include determining and/or re-determining the overall impact score 206 while the machine 218 is present in the environment. In some embodiments, re-determining the overall impact score 206 may include re-determining (or confirming) the presence or value of one or more factors 216 in the environment, redetermining one or more weights corresponding to the one or more factors 216, adding one or more factors 216 and/or information classes 212 to a determination of one or more performance ability scores 214, re-determining one or more performance ability scores 214 corresponding to respective information classes 212, etc.

In some embodiments, the performance determination module 204 may determine a first overall impact score 206 corresponding to the machine 218 and the environment at a first time stamp. Additionally or alternatively, the performance determination module 204 may determine a second overall impact score 206 corresponding to the machine 218 and the environment at a second time stamp where the first overall impact score 206 and the second overall impact score 206 may not be the same. In some embodiments, the second overall impact score 206 may not be the same as the first overall impact score 206 because of one or more changes in the machine information 210, previously collected data, and/or the environmental data 208.

For example, in the context of the machine 218 as an ego-machine, the machine information 210 may indicate that the machine 218 may be travelling at a first speed, the machine 218 may be in a first transmission gear, and the suspension may be in a first position. In response to the first overall impact score 206 indicating that the environment, in a particular time of day and/or year, may be rated as an off-roading environment, the machine 218 may decrease its speed, downshift (e.g., from fourth gear to second gear), and raise the suspension of the ego-machine. Further, the performance determination module 204 may re-determine the overall impact score 206 in response to the change in the machine information 210. Continuing the example, the overall impact score 206 corresponding to the machine 218 and the environment may decrease in response to the changes to the ego-machine that may be indicated using the machine information 210.

In some embodiments, the performance determination module 204 may dynamically determine the overall impact score 206 based on one or more changes to the environmental data 208. For example, in the context of the machine 218 as an ego-machine, a first overall impact score 206 may be influenced by one or more factors 216 that may indicate that the environment may not include clear lane markers. In response to the first overall impact score 206, one or more perception modules, systems, etc. corresponding to the ego-machine may generate, form, and/or synthesize one or more virtual lanes or virtual lane markers. In response to the virtual lane markers being present, the performance determination module 204 may redetermine the overall impact score 206 to reflect the changes to the environment after having formed the virtual lane markers. Continuing the example, the re-determined overall impact score 206 may decrease the overall impact score 206 that may reflect the reduction in impact to the ego-machine within the environment.

Modifications, additions, or omissions may be made to FIG. 2 without departing from the scope of the present disclosure. For example, the amount of machine information 210, 202, and/or environmental data 208 used, the number of information classes 212, performance ability scores 214, factors 216, and/or overall impact scores 206 may vary. Further, the performance determination module 204 may be included in the machine 218. In some embodiments, the performance determination module 204 may be included in one or more other systems that may direct one or more operations corresponding to the machine 218. Additionally or alternatively, number of times that the performance determination module 204 may redetermine the overall impact score 206 may vary.

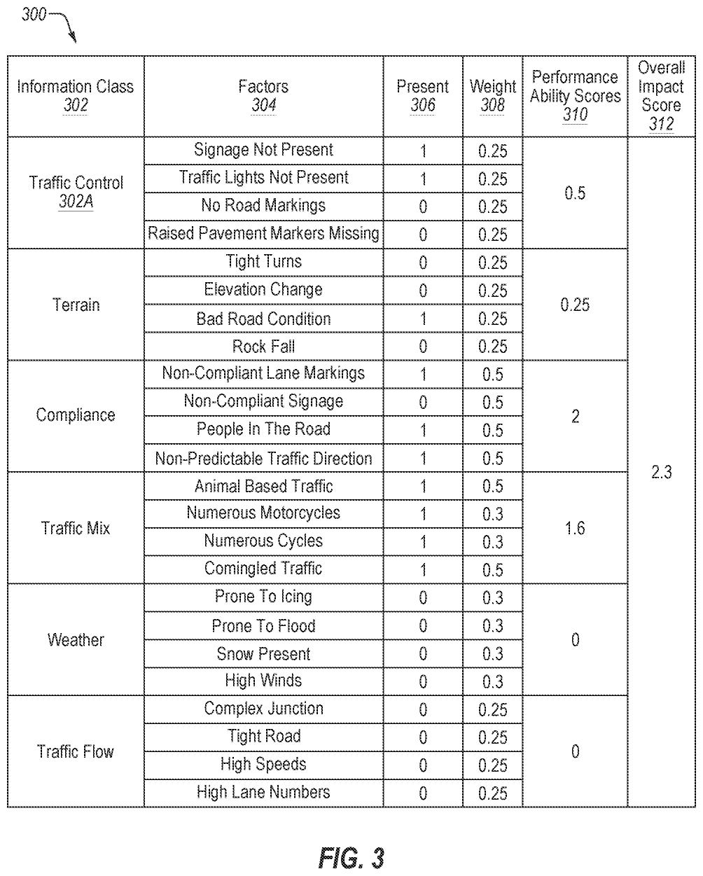

FIG. 3 is an example chart 300 corresponding to generating an overall impact score 312 associated with factors that may affect performance of autonomous or semi-autonomous driving operations by an ego-machine, in accordance with one or more embodiments of the present disclosure. In some embodiments, the chart may include one or more information classes 302, factors 304, and/or performance ability scores 310.

In some embodiments, the chart 300 may illustrate an example backend organization corresponding to one or more operations that may be performed to generate one or more overall impact scores 312. In some embodiments, the chart 300 may correspond to one environment and one or more respective charts similar to the chart 300 may be organized to correspond to one or more additional operations that may be performed to determine and/or generate one or more additional overall impact scores 312 corresponding to one or more other environments and/or associated with one or more other machines.

In some embodiments, the chart 300 may include one or more information classes 302. In some embodiments, the one or more information classes 302 may be one or more examples of information classes 112 related to ego-machine operations and, in particular, autonomous or semi-autonomous vehicle operations as described and/or illustrated further in the present disclosure, such as, for example, with respect to FIG. 1. In some embodiments, example information classes 302 illustrated in FIG. 3 may include traffic control 302A, terrain, compliance, traffic mix, weather and/or traffic flow. In some embodiments, individual information classes 302 may include one or more factors 304 that may be used to determine an impact to autonomous driving operations performed by the ego-machine in a particular environment.

In some embodiments, the one or more factors 304 may correspond to one or more potential impacts to the ego-machine in the particular environment. In some embodiments, the one or more factors 304 may include any relevant variable, characteristic, or other impact that may affect the ego-machine and/or one or more operations corresponding to the ego-machine while the ego-machine may be within a particular environment. For example, any relevant variable, characteristic, etc. that may impact perception, handling, battery life, fuel capacity, communication, and any other variable or characteristic corresponding to an autonomous vehicle in the particular environment. In these or other embodiments, the one or more factors 304 that may correspond to potential impacts to the ego-machine and/or one or more operations to the ego-machine may be examples of the factors 116 described and/or illustrated further in the present disclosure, such as, for example, with respect to FIG. 1.

In some embodiments, the factors 304 may correspond to one or more information classes 302. For example, the information class 302A may be “traffic control.” Further, the information class 302A may include one or more factors 304, such as, for example, signage not being present, traffic lights not being present, no road markings, missing raised pavement markers, etc. In some embodiments, each of the factors 304 corresponding to the information class, “traffic control” 302A may include potential impacts to the ego-machine corresponding to traffic control in the particular environment. In some embodiments, example factors 304 corresponding to other example information classes 302 may be illustrated in the chart 300.

In some embodiments, a presence 306 of one or more of the factors 304 may be determined. In some embodiments, it may be determined that the one or more factors 304 corresponding to the environment and respective information classes 302 may be present or absent from the environment. In some embodiments, the presence 306 may be indicated using a binary “1” or “0” where a “1” may indicate that one or more factors 304 may be present in the environment and where a “0” may indicate that the factor 304 may be absent from the environment. In these and other embodiments, the presence 306 of one or more factors 304 may be described further in the present disclosure, such as, for example, with respect to FIG. 1 as described with respect to expression 1.

In some embodiments, a weight 308 corresponding to the one or more factors 304 may be determined and/or assigned to the one or more factors 304. In some embodiments, the factors 304 may be assigned a weight 308 based on an amount that the presence 306 of the factors 304 may affect the ego-machine and/or one or more operations of the ego-machine. In some embodiments, the weight 308 may be assigned to the one or more factors 304 based on the severity of the impact of the one or more factors 304 on the ego-machine. In some embodiments, the weights 308 may include one or more integers. Additionally or alternatively, the weights 308 may include one or more other data types that may convey information indicating respective weights 308 corresponding to respective factors 304. In these and other embodiments, determining and/or assigning the weights 308 associated with the one or more factors 304 may be described further in the present disclosure, such as, for example, with respect to FIG. 1 as described with respect to expression 1.

In some embodiments, the chart 300 may include one or more performance ability scores 310, which may each correspond to one of the information classes 302. In some embodiments, the performance ability scores 310 may indicate an aggregation of the impact that the one or more factors 304 of the corresponding information classes 302 may have on the ego-machine in the particular environment. In some embodiments, the individual performance ability scores 310 may be determined and/or calculated based on the presence 306 of one or more factors 304 and the respective weight 308 determined associated with one or more respective factors 304.

In some embodiments, the individual performance ability scores 310 that may each correspond to one of the information classes 302 may be determined and/or calculated based on, for example, expression 1. For example, a performance ability score included in the individual performance ability scores 310 may be determined for the information class 302 associated with traffic control 302A. It may be determined that two of the factors 304 are present: “Signage not present” and “traffic lights not present” indicated using a “1.” Further, it may be determined that two factors 304 may not be present: “No road markings” and “raised pavement markers missing” indicated using a “0.” Continuing the example, the weights 308 corresponding to each of the factors 304 may be the same. Using equation (1), the performance ability score included in the individual performance ability scores 310 corresponding to traffic control information class 302A may be determined, for example, as shown using expression (1) below:

$${F}_{n} = ( 1 ) ( 0.25 ) + ( 1 ) ( 0.25 ) + ( 0 ) ( 0.25 ) + ( 0 ) ( 0.25 ) = 0.5 \qquad ( 1 )$$

In some embodiments, equation (1) may not be used. Instead, one or more other functions or expressions may be used to determine individual performance ability scores 310 that may each correspond to one of the information classes 302 may be determined based on one or more respective factors 304.

In some embodiments, an overall impact score 312 may be generated, determined, and/or calculated based on the performance ability scores 310. In some embodiments, the overall impact score 312 may represent an overall set of circumstances and/or potential risks that may affect an ego-machine operating in the environment. Additionally or alternatively, the overall impact score 312 may represent an overall set of circumstances and/or potential risks that may affect one or more operations performed by the ego-machine in the environment. In some embodiments, the overall impact score 312 may represent an aggregation of the individual performance ability scores 310 thereby indicating an amount of impact to the ego-machine including impacts to the ego-machine associated with each information class 302. In some embodiments, the overall impact score 312 may be determined using one or more formulas, expression, equations, etc. In some embodiments, the overall impact score 312 may be determined using equation (2) defined in the present disclosure. In some embodiments, a form of a weighted average or Minkowski sum may be used to indicate the overall impact score 312.

Modifications, additions, or omissions may be made to FIG. 3 without departing from the scope of the present disclosure. For example, the number of information classes 302 represented, the number of corresponding factors 304, the magnitude and/or presence 306 of the weights 308 corresponding to respective factors 304, the number of performance ability scores 310 may vary. Further, the magnitude of the overall impact score 312 may vary. In some embodiments, the method(s) of determining the performance ability scores 310 and/or the overall impact score 312 may vary. Additionally or alternatively, the chart 300 may be an example of one or more charts that may correspond to respective environments and systems.

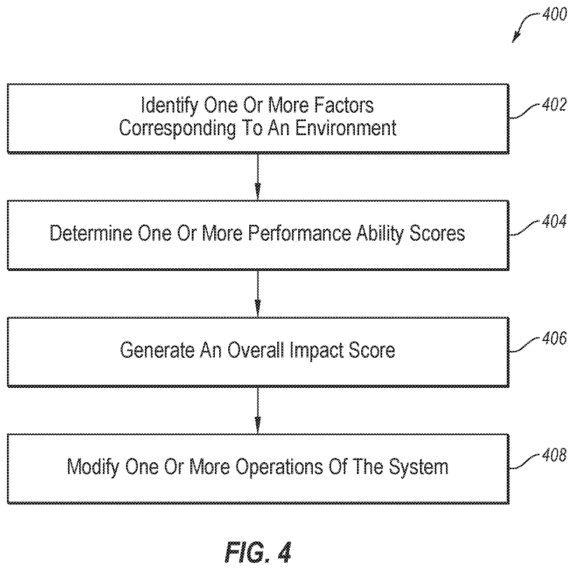

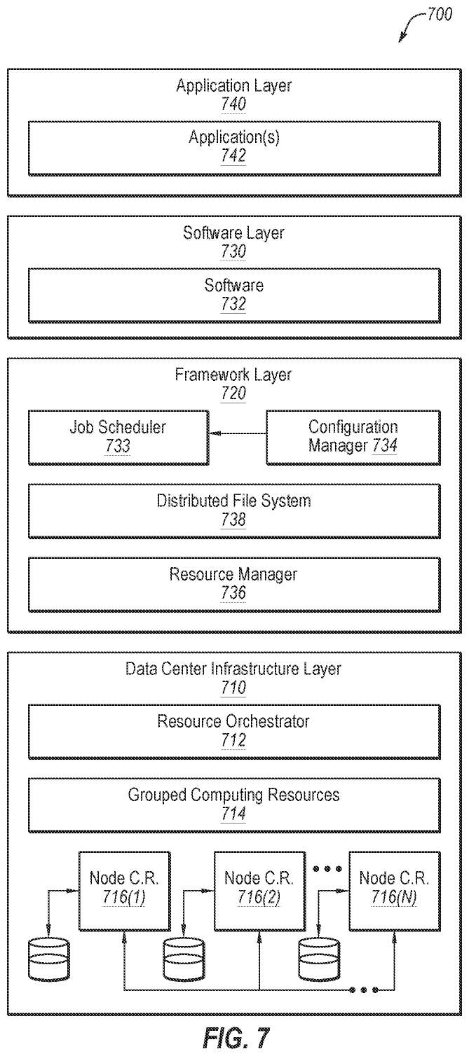

FIG. 4 is a flow diagram showing a method 400 for modifying one or more operations of a system based on an overall impact score, in accordance with one or more embodiments of the present disclosure. One or more operations of the method 400 may be performed by any suitable system, apparatus, or device such as, for example the performance determination module 104, the control module 108, and/or the machine 118 of FIG. 1, the performance determination module 204 and/or the machine 218 of FIG. 2, the autonomous vehicle system(s) described with respect to FIGS. 5A-5D, computing device(s) described with respect to FIG. 6, and/or the data system(s) described with respect to FIG. 7 in the present disclosure.

The method 400 may include one or more blocks 402, 404, 406, and 408. Although illustrated with discrete blocks, the operations associated with one or more of the blocks of the method 400 may be divided into additional blocks, combined into fewer blocks, or eliminated, depending on the particular implementation.

In some embodiments, the method 400 may include block 402. At block 402, one or more factors corresponding to an environment may be identified—e.g., the factors 116, the factors 216, and/or the factors 304 described and/or illustrated with respect to FIGS. 1, 2, and 3. In some embodiments, the one or more factors may respectively impact one or more operations of a system. Further, in some embodiments, the one or more factors may be respectively weighted based at least on an amount of impact respectively caused to one or more operations of the system. In these or other embodiments, the factors may be weighted as described and/or illustrated in the present disclosure, such as, for example with respect to the factors 116 in FIG. 1 and the weight 308 of the factors 304 described with respect to FIG. 3.

In some embodiments, the one or more factors may correspond to one or more information classes (e.g., information classes 112, information classes 212, and/or information classes 302) that may categorize the one or more factors into respective groups of one or more factors. In some embodiments, the one or more factors grouped may include one or more factors that may impact one or more operations corresponding to the system that may be weighted based at least on an amount of impact the one or more factors may have on one or more operations of the system in the environment.

At block 404, one or more performance ability scores may be determined—e.g., performance ability scores 114, performance ability scores 214, and/or performance ability scores 310. In some embodiments, the one or more performance ability scores may be determined respectively corresponding to one or more information classes that may correspond to the one or more factors, the determining the performance ability scores may be described further in the present disclosure, such as, for example, with respect to performance ability score 114 and performance ability score 214 described with respect to FIGS. 1 and 2.

In some embodiments, the one or more information classes may include respective subsets of the one or more factors such that the one or more factors may be categorized according to the respective information classes to which the one or more factors may correspond which may be illustrated with respect to the factors 304 and/or information classes 302 described with respect to FIG. 3. In some embodiments, the one or more performance ability scores may indicate respective impacts that may be associated with performance of one or more operations corresponding to the system as respectively impacted by the one or more corresponding information classes, and that may be determined based at least on the one or more factors in the environment corresponding to the one or more information classes. In these or other embodiments, determining the performance ability scores based on one or more factors may be described and/or illustrated further in the present disclosure such as, for example, with respect to the performance determination module 104 and/or the performance determination module 204 described with respect to FIGS. 1 and 2.

At block 406, an overall impact score may be generated—e.g., the overall impact score 106, the overall impact score 206, and/or the overall impact score 312. In some embodiments, the overall impact score may convey information regarding one or more impacts of the system in the environment based at least on a magnitude of one or more of the one or more performance ability scores. In some embodiments, the overall impact score may additionally be determined based at least on data generated using one or more sensors that may correspond to the system; the determining the overall impact score may be described with respect to the performance determination module 104 and/or 204 in FIGS. 1 and 2 respectively.

In some embodiments, the overall impact score may be determined or re-determined when the system enters the environment. Additionally or alternatively, the overall impact score may be determined prior to the system entering the environment; for example, an overall impact score 206 may be generated using previously collected data 202 and/or machine information 210 described, for example, with respect to FIG. 2. In some embodiments, the overall impact score may be generated based at least on the magnitude of the one or more performance ability scores by performing a Minkowski summation using at least one of the performance ability scores. In these or other embodiments, an overall impact score may be determined, synthesized, and/or generated as described and/or illustrated further in the present disclosure, such as, for example, with respect to FIGS. 1, 2, and 3.

At block 408, one or more operations of the system may be modified—e.g., using the control commands 110 described with respect to FIG. 1. In some embodiments, the one or more operations, settings, or configurations of the system may be modified based at least on the overall impact score. In some embodiments, the one or more operations of the system may be changed in the environment based at least on the one or more factors in the environment and/or the one or more performance ability scores. In these or other embodiments, the operations of the system may be modified using one or more control commands 110 generated using the control module 108 described and/or illustrated further in the present disclosure, such as, for example with respect to FIG. 1.

Modifications, additions, or omissions may be made to one or more operations included in the method 400 without departing from the scope of the present disclosure. For example, the operations of method 400 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more CPU(s), system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, and/or to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) 546 (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the HD map 522 of FIG. 5C), location data (e.g., the location of the vehicle 500, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524, which may use one or more wireless antenna(s) 526 and/or modem(s) to communicate over one or more networks. For example, the network interface 524 may be capable of communication over LTE, WCDMA, UMTS, GSM, CDMA2000, etc. The wireless antenna(s) 526 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward-facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may any number of wide-view cameras 570 on the vehicle 500. In addition, long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

One or more stereo cameras 568 may also be included in a front-facing configuration. The stereo camera(s) 568 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360-degree camera(s), and/or the like. For example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround-view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C is illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500 and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting, and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected to both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500-such as processing DNNs. In addition, the SoC(s) 504 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 516 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe-stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always-on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528, which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPD (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data, in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surrounding at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 160m (front) or 80m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5m, 4m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 100m, with an accuracy of 2 cm-3 cm, and with support for a 100 Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network that is trained and thus reduces the risk of false positives, as described herein.

The vehicle 500 may further include the infotainment SoC 530 (e.g., an in-vehicle infotainment system (IVI)). Although illustrated and described as an SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 500. For example, the infotainment SoC 530 may include radios, disk players, navigation systems, video players, USB and Bluetooth connectivity, carputers, in-car entertainment, Wi-Fi, steering wheel audio controls, hands-free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe-stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point, connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, include wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716 (N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 732, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716 (N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 700. In at least one embodiment, trained or deployed machine learning models corresponding to one or more neural networks may be used to infer or predict information using resources described in the present disclosure with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
identifying a plurality of factors corresponding to an environment, the plurality of factors respectively impacting operation of a system and being respectively weighted based at least on an amount of impact respectively caused to operation of the system;
determining a plurality of performance ability scores respectively corresponding to subsets of the plurality of factors, the plurality of performance ability scores indicating respective impacts associated with performance of one or more operations corresponding to the system as respectively impacted by the corresponding subsets of the plurality of factors;
generating an overall impact score, the overall impact score conveying information regarding one or more impacts to the system in the environment based at least on a magnitude of one or more of the plurality of performance ability scores; and
modifying one or more operations of the system based at least on the overall impact score.

2. The method of claim 1, wherein the one or more operations of the system are changed in the environment based at least on one or more of the plurality of factors in the environment, or the plurality of performance ability scores.

3. The method of claim 2, wherein the one or more operations of the system include at least one of: forming one or more virtual lanes, adjusting a suspension of the system, increasing speed, decreasing speed, adjusting one or more settings, or adjusting a route.

4. The method of claim 1, wherein the overall impact score is additionally determined based at least on data generated using one or more sensors corresponding to the system.

5. The method of claim 4, wherein the overall impact score is determined, re-determined, or confirmed when the system enters the environment.

6. The method of claim 1, wherein at least one performance ability score is determined prior to the system entering the environment, and at least one other performance ability score is determined while the system is in the environment.

7. The method of claim 1, wherein the plurality of factors corresponds to one or more information classes corresponding to the environment, the one or more information classes categorizing the plurality of factors into respective groups of one or more factors, the one or more factors including the one or more factors that impact operation of the system weighted based at least on an amount of impact the factors have on one or more operations of the system in the environment.

8. The method of claim 1, wherein the plurality of factors include at least one of high lane numbers, high speed, icing, snow, rain, wind, hail, pedestrians, non-predictable traffic direction, tight turns, rock fall, wildlife warnings, time of day, time of year, elevation change, or no road markings.

9. The method of claim 1, wherein the generating the overall impact score based at least on the magnitude of the plurality of performance ability scores is performed using a Minkowski summation.

10. A system comprising:
one or more processing units to perform operations comprising:
identifying a plurality of factors corresponding to an environment, the plurality of factors respectively impacting operation of a system and being respectively weighted based at least on an amount of impact respectively caused to operation of the system;
determining a plurality of performance ability scores respectively corresponding to subsets of the plurality of factors, the plurality of performance ability scores indicating respective impacts associated with performance of one or more operations corresponding to the system as respectively impacted by the corresponding subsets of the plurality of factors;
generating an overall impact score, the overall impact score conveying information regarding one or more impacts to the system in the environment based at least on a magnitude of one or more of the plurality of performance ability scores;
generating a map of the environment including one or more sub-areas and one or more overall impact scores corresponding to the one or more sub-areas; and
modifying one or more operations of the system based at least on the overall impact score corresponding to the one or more sub-areas in the map.

11. The system of claim 10, wherein the one or more operations of the system are changed in the environment based at least on one or more of the plurality of factors in the environment, or the plurality of performance ability scores.

12. The system of claim 11, wherein the one or more operations of the system include at least one of: forming one or more virtual lanes, adjusting a suspension of the system, increasing speed, decreasing speed, adjusting one or more settings, or adjusting a route.

13. The system of claim 10, wherein the overall impact score is additionally determined based at least on data generated using one or more sensors corresponding to the system.

14. The system of claim 13, wherein the overall impact score is determined, re-determined, or confirmed when the system enters the environment.

15. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for implementing one or more large language models (LLMs);
a system for generating synthetic data;
a system incorporating one or more virtual machines (VMs);
a system implemented at least partially in a data center; or
a system implemented at least partially using cloud computing resources.

16. A processor comprising processing circuitry to perform operations, the operations comprising:
identifying a plurality of factors corresponding to an environment, the plurality of factors respectively impacting operation of a system and being respectively weighted based at least on an amount of impact respectively caused to operation of the system;
determining a plurality of performance ability scores respectively corresponding to subsets of the plurality of factors, the plurality of performance ability scores indicating respective impacts associated with performance of one or more operations corresponding to the system as respectively impacted by the corresponding subsets of the plurality of factors;
generating an overall impact score, the overall impact score conveying information regarding one or more impacts to the system in the environment based at least on a magnitude of one or more of the plurality of performance ability scores; and
modifying one or more operations of the system based at least on the overall impact score.

17. The processor of claim 16, wherein the one or more operations of the system are changed in the environment based at least on one or more of the plurality of factors in the environment, or the plurality of performance ability scores.

18. The processor of claim 17, wherein the one or more operations of the system include at least one of: forming one or more virtual lanes, adjusting a suspension of the system, increasing speed, decreasing speed, adjusting one or more settings, or adjusting a route.

19. The processor of claim 16, wherein the overall impact score is additionally determined based at least on data generated using one or more sensors corresponding to the system.

20. The processor of claim 19, wherein the overall impact score is determined, re-determined, or confirmed when the system enters the environment.
